(19) United States
(12) Patent Application Publication
(10) Pub. No.: US 2006/0060016 A1
(43) Pub. Date: Mar. 23, 2006

(54) Power conversion system

(76) Inventor: Gerald Peter Mazza, Pinellas Park, FL (US)

Correspondence Address: Gerald Peter Mazza, 3790 70th Ave. North, Pinellas Park, FL, 33781, US

(21) Appl. No.: 10/944,654

(22) Filed: Sep. 20, 2004

(51) Int. Cl. F16H 27/00

(52) U.S. Cl. 74/111

(57) ABSTRACT

The present invention is a Power Conversion and Transfer System with an “above average efficiency”. The higher efficiency is provided because of the new systems unique configuration, which is endowed with a “changing mechanical advantage”, and by which a higher then average “variable output force” is made available for use. Conventional Mechanical Power Conversion and Transfer Systems of today are basically an assortment of “levers or simple machines”. All have various configurations and combinations with their input and output forces typically of a constant or a “uniform velocity ratio”. Importantly in the new levers design, is that the Applied Effort Force is of a “Uniform Velocity”, and more importantly is that its Resistance output Force is prepared to be of a “variable velocity”, which is declining during its motion or stroke cycle. The value of the declining “variable” output force when defined mathematically and “averaged out”, presents a new and useful “above average output force”, resulting in a high efficiency. The new inventions unique configuration is fashioned primarily like a “circle or disc lever”. It sits upright like a wheel on a road, while the input and output forces power it to rock or cycle to and fro on its support base. This new disc lever arrangement has the capacity to provide an “above average output force”, “in a certain given distance and or time cycle”. Energy is simply the ability to do a “measured amount of work” in a certain distance and or time increment. These principles of “work” are illustrated and demonstrated within the workings of this new invention.

### BACKGROUND OF THE INVENTION

Conventional Mechanical Power Conversion and Transfer Systems of today are basically an assortment of “levers or simple machines”. All have various configurations and combinations with their input and output forces typically of a constant or a “uniform velocity ratio”.

Note: Because of the very difficult nature of the subject matter contained with the development of this invention, an extra bit of concentration by the builder or engineer is necessary to comprehend its principles. These principals mainly involve the “Theory of the Virtual Velocities”; Physics, Geometrics, Mathematics, Hydraulics, pneumatics, Applied Mechanics, and Electro Mechanics.

The present invention is a Power Conversion and Transfer System with an “above average efficiency”. The higher efficiency is provided because of the new systems unique configuration, which includes a movable fulcrum which provided a “changing mechanical advantage”. This combination provides a changing force velocity ratio of which a higher then average “variable output force” is made available for use.

The new inventions unique lever configuration is fashioned primarily within a “circle or disc lever”. It sits upright like a wheel, on a road. It has an Effort Force applied at the discs axis, with alternate left and right side output forces. This configuration of parts and forces allows the disc to rock and roll, reciprocate and or cycle to and fro on its support base. This new disc levers “variable mechanical advantage and its output force” arrangement provides the capacity to provide an “above average efficiency”.

Importantly, the Applied Effort Force is of a “Uniform Velocity”, and more importantly its Resistance output Force is provided to be of a “variable velocity”, which is declining during its motion or stroke cycle.

The average value of the “variable” output force, when defined mathematically, presents an “above average output force”. Its value is based on an output force supplied from a single disc unit. Importantly the above average work output is done in a certain “overall” distance and or time cycle. The higher then average output force when “compounded” with several disc units, (separate units in a common series force compounding configuration) can multiply and make available new highs in output efficiency.

In “applied mechanics and physics”, the quantity of work done is defined: If a force is not constant, then the work done equals the “average value” of the force, times the displacement of the particle parallel to the direction of the force. This work formula confirms the above average value of the new Disc Lever Units variable output force.

The present inventions above average efficiency, is provided because of a higher then average “variable output force” and is made available for use; efficiency, is defined as;
(where n=efficiency/w=work)

$$η = \frac{{W}_{out}}{{W}_{in}}$$

This variable output force starts out at a higher force and declines to a lower place where a comparable (in distance and or time cycle exists) conventional R output force is at. When equilibrium of the Effort and Resistance forces occurs motion of the disc stops, reverses direction, and continually repeats this declining output force process in to and fro cycles of motion and rest.

The Effort and Resistance forces are situated primarily at selected points on, about, or around the Disc.

Where the disc sits upright on its tangent support base is a very important part which is its “movable fulcrum arc”. This arc is a certain measured and selected segment of the discs circumference. This fulcrum arc provides a controlled changing mechanical advantage and changing moment arm ratio. With motion of the disc lever on its movable fulcrum, the Resistance moment arm actually “grows in length” while the Effort moment arm remains a constant (radius of the disc) length. This growing in length R moment arm provides for a controlled decline of the R output force. This being a 3^{rd} class lever: the E force is applied between the fulcrum and the R force output. The longer the R moment arm the lesser the R force output, and this growing length provides a declining variable output force. This critically guided (positive accelerated velocity) variable R output force starts out at “a higher magnitude and declines” to a lower force magnitude where it meets equilibrium or a conventional state and the motion cycle stops.

By adding the high and the low force value of incremental readings, and dividing that number by the number of incremental readings taken. This provides its average output force. One must “compare this higher output force value” with that of a conventional lever's pinned fulcrum and its “constant output force”. This conventional lever has a constant lower output force. This conventional constant force compares with that output force of the new lever only when the new lever's work is done at the finish of its declining force stroke cycle. Both the conventional and new lever with its selected arc segment have the “same overall distance and or time cycle”. The new disc lever is providing an above average variable output force (because of its changing mechanical advantage) as compared with the conventional pinned fulcrum lever system, with its uniform force output.

Energy is simply the ability to do a “measured amount of work” in a certain distance and or time increment.

These principles of “work” are illustrated and demonstrated within the workings of this new invention.

The term variable velocity implies the ability to change the speed ratio by “small increments” over the entire range of control while the drive is under load. This also allows one to calculate its output force at any given point in its travel, or motion cycle.

The working principals of a crowbar as they apply to this new invention must be expounded upon here:

A crowbar is a bent lever, which separates the E and R forces and which have arms pivoting on, or bearing points on devices called “movable fulcrums” and resting this movable fulcrum on the floorboard or whatever as a support base. Did you ever notice that when using a crow bar to pull a nail or spike, that when the fulcrums contact point on the floor or support moves or rolls further away from the nail or work (the resistance arm is growing in length), that you must apply more Effort force to the effort arm of the crowbar (or hammer handle) to continue pulling the spike and having motion occur. This is similar to the workings of the growing R moment arm length within this new lever assembly.

In its motion cycle is a place where the new disc units overall E and R force traverse distance and or time segment (its virtual velocity ratio) matches that traverse distance and or time segment cycle of this said conventional lever system. This is the place in its travel cycle where equilibrium occurs and motion stops changes direction for another motion cycle.

### DESCRIPTION OF THE PRIOR ART

The use of mechanical power conversion systems of previously known designs and configurations were mainly devised for the purpose of transferring power as input forces to output forces through various methods and apparatuses.

In this respect, the power conversion system according to the present invention substantially departs from the conventional concepts and designs of the prior art. In doing so it provides an apparatus primarily developed for the purpose of providing an above average efficiency in the transferring of power.

These critical specifications such as in the drawings, can be “transposed to any size circle or disc”. Also favored and “selected” are high efficiency fulcrum arc segments with large or small displays of motion, such as 16.226 degrees arcs to some with small displays of motion such as a 2 degree fulcrum arc which constitutes a selected roll traverse distance increment as it cycles along its support base.

This circle lever is illustrated herein as a 3^{rd} class lever, where the Effort force is placed between the Resistance and the fulcrum. Also, the E and R force points of connection to the disc can be reversed for various needs and still provide an above average force output. These proportionately altered levers and force locations may affect the lever to be changed from a third class to a 1^{st} or 2^{nd} class lever assembly. These E and R forces can be critically and proportionately relocated and moved anywhere in, on, or about the disc and applied mechanically, hydraulically, electro-mechanically or other.

The only part of the disc that is needed is the critically selected “fulcrum arc segment”. The rest of the disc can be cut away. This cutting away is a method used in some modifications using custom proportionate “added on lever lengths” to the fulcrum arc piece and critically located in various advantageous places. This method provides and allows for a smaller more practical, “job rated” transmission case and or power conversion system.

The new disc lever unit can be modified for use in the raising of the efficiency of various machines. This includes all type automobile, trucks, locomotive, various hybrid vehicles, large and small power plants, boats, industrial equipment, aeronautical and space machines, electromechanical, power boosters, among many others etc.

### SUMMARY OF THE INVENTION

The general purpose of the present invention is illustrated subsequently in greater detail. It is to provide a new and improved power conversion system and method, which has all the advantages of the prior art and none of the disadvantages.

With motion of the disc on its base, the movable fulcrum “changes the orientation” of the R output lines of force, which cause the R moment arm to grow in length (see FIG. 1). This growing R moment arm provides a higher and variable starting R output force, which declines as its forces seek and find equilibrium and or rest.

The term variable velocity implies the ability to change the speed ratio by “small increments” over the entire range of control while the drive is under load.

The disc lever for our example illustrations has a vertical diameter of 14.125 inches measured from the free tip ends of the ring gear or pinion teeth. This pinion has two sets of ring gear teeth, and a steel tire of the same diameter sandwiched in between them. These teeth are preferably of a smaller kind and are adapted to contact and mesh with the support base rack teeth. The narrow metal tire has a 14.125″ diameter is sandwiched between these teeth. This metal tire runs on a rail within the rack like a train wheel. This allows the pinion to rock and roll, and work along on its movable fulcrum arc in a linear path of travel on the support base rack. This combination of ring gear, steel tire and rail prevents sliding or translation of the pinion on the support base rack from occurring when this disc is under the stress of force in its travel cycle.

One modification for illustration as in FIG. 3 is a 16.226 degree fulcrum arc segment and roll cycle. It has a “starting E and R moment arm ratio” of 1.94983-1 more or less. This provides an “above average starting R output force” which declines and stops where equilibrium of the forces is achieved. The “finish moment arm ratio” grows to a 2-1 lever ratio and its here where the E and R forces are at equilibrium and also the point where it compares with that output of a conventional lever's output. “All conventional levers are at equilibrium whether in motion or at rest”. The Effort force applied at the axis traversed 2″ (16.226°), while the resistance force output is at the top and travels 4″. When the finish moment arm ratio reaches a 2-1 ratio, equilibrium is achieved and motion stops and changes to the opposite direction for another equilibrium seeking roll or motion cycle. As the changing length R moment arm grows in length it loses R force output proportionate to its growth.

As the disc continues into its roll cycle it gains advantage of position which allows for a return trip or cycle in the opposite direction which also “makes available” the identical declining above average output force for use.

It is important, that the claims be regarded as including such equivalent constructions insofar as they do not depart from the spirit and scope and themes of the present invention.

The main object of the present invention is to provide a power conversion system for very efficiently transferring power from controlled input effort forces of uniform velocity to new and useful output resistance forces of variable velocity.

By the use of combining together of several new disc lever units, the input and output E and R forces are compounded. This configuration utilizes “series compounding” using the principals and laws of the “compound lever”. It is necessary to compound these E and R forces hydraulically and or by the use of common hydraulic cylinders, multi-stage cylinders, various hydraulics, and or Electro-hydraulics, etc.

Note, that with series compounding, that the “variable R output force” of the 1^{st} unit becomes a variable input E force applied at the axis of the next disc, etc. This is done hydraulically and applied proportionately to the input Effort force of the next unit etc., etc.

In general then, to compute the mechanical advantage of any compounding machine, first find the mechanical advantage of each separate element and then find the product of the separate advantages.

### DESCRIPTION OF THE DRAWINGS

FIGS. 1 through 5 are elementary views of the invention.

FIG. 6 is a view of the invention using the Laws of the Compound Lever. The drawings provide illustrations all of which show principles which may be used and adapted to hybrid vehicles, electric vehicles, power plants, and others, etc.

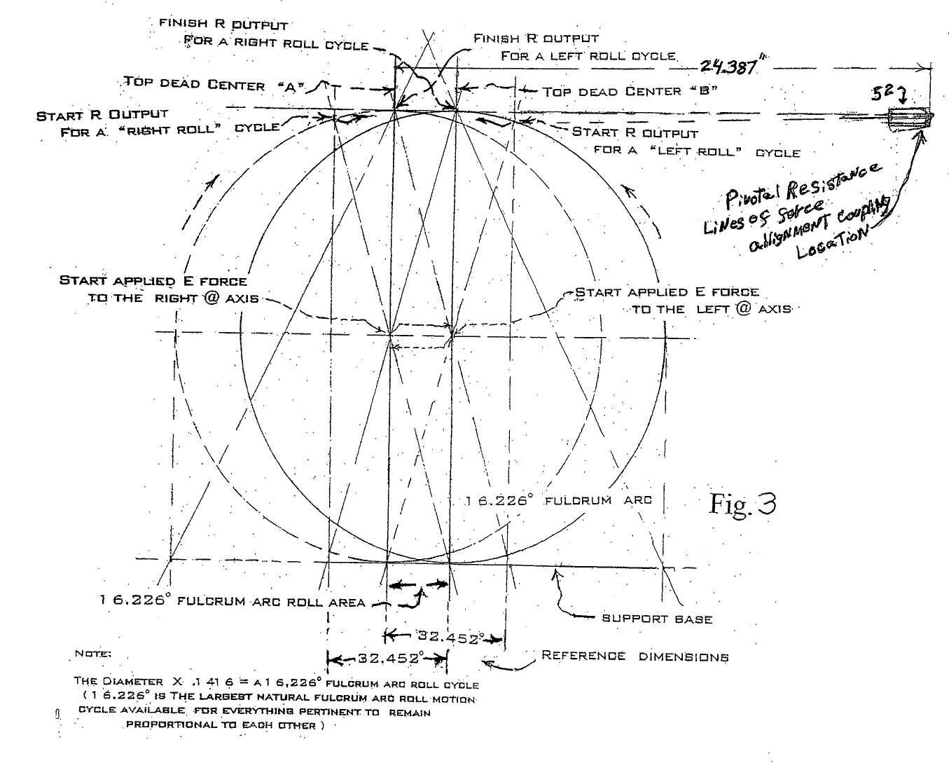

Note that in FIG. 3, the 24.387″ dimension to the right direction (parallel to the base 14) from “top dead center”, provides for setting up a “proper trajectory” of the R output lines of force as they relate to the start and finish R moment arms keeping them at “90 degrees” to each other.

This same spread (T.D.C. to pivotal R output location FIG. 3) distance 24.387″ is required to develop and select all the various fulcrum arc roll (when using a 14.125″ disc) modifications and their correct changing R moment arms along the 64 degree length of the support base as “potential fulcrum arc work areas”. Using a smaller disc diameter size would require a “proportionately lesser” spread distance from top dead center. Also, this said 24.387″ location, can be modified and moved about somewhat by model testing for other output efficiency advantage locations, while still establishing and keeping the “lines of force and moments of force at 90 degrees” to each other.

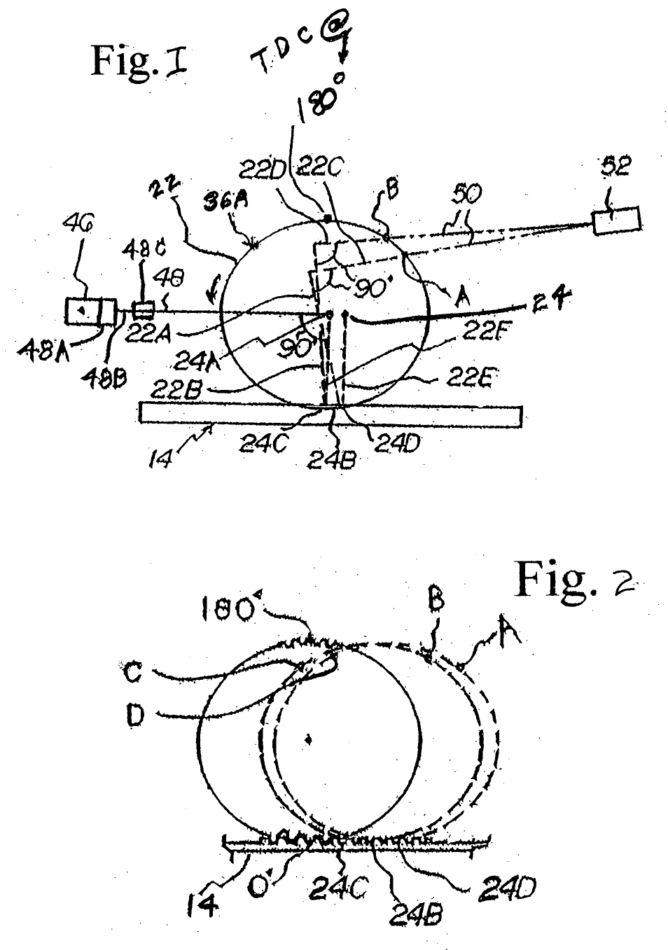

A builder also can use other E and R force modifications in a similar manner as shown in FIGS. 1 and 2, as mentioned. FIG. 1 also shows the start and finish positions of the E moment arm 22e and 22f, and R moment arms 22a and 22b, along with the start and finish positions of the E and R lines of force 22c and 22d which always remain at right angles to their respectful moments of force (22a and 22b). The growth of the right side R moment arm is the only side shown as the unit “rolls in the left” direction on its support base. The left side motion and Resistance moment arm growth cycle is the same as the right side, and is done in the right direction, alternately in cycles of motion and rest.

FIG. 2 is a schematic illustration relating to the positioning of the pinion with its right side A, B and left side C, D points of R force output as the pinion sits on its rocking and rolling working area on the horizontal support base rack 14.

FIG. 3 is a schematic illustration our standard 16.226 degree roll cycle of the disc on the support base. Also the drawing relates to the positioning of the Disc Unit on its support base. Importantly shown and for study are all the reference lines, and reference points, along with the start and finish Effort and Resistance force points of application. Especially important are the locating of the “two Top Dead Center lines, A and B”. These two Top Dead Center vertical lines are necessary for locating all the various points of importance, such as the start and finish points of R output.

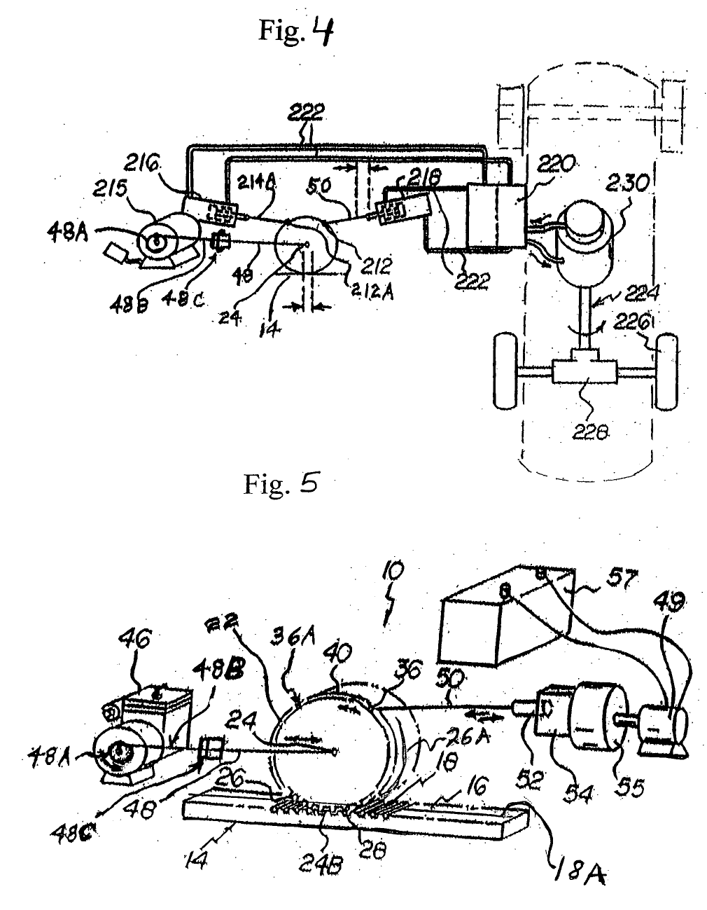

FIG. 4 is a schematic illustration of an alternate embodiment of the invention which is in the form of a hybrid vehicle. This modification illustrates an electric motor (it can be internal combustion or other) providing effort forces to the axis of the circular gear member while illustrating two given points of R output at the upper right and left side of the periphery including a right and left side one way hydraulic R output cylinder piston pumps 218 and 216 which are connected by second and third attachment members 214 and 214a connected with pins and bushings to the periphery of the pinion as it sits on its support base rack. It should be noted that this illustrated double R output configuration is a normal function of the circular gear member and its system of parts and forces for this modification. A to and fro reciprocation cycle occurs with this said circular gear member and the rocking and rolling process of its fulcrum arc is provided on its support base 14. In this to and fro cycling process, one R force (at a time 212) output is providing above average (and declining) R forces whole the other side 212a is under no stress of force and is in its recycling process gaining the advantage of position, preparing for its power roll cycle in the opposite direction, etc.

FIG. 5 is a perspective illustration of a power conversion system constructed in accordance with the principles of the present invention in a hybrid modification. The Effort force is applied at the discs axis at 24. There are two alternate upper R force outputs shown at 36 and 36a. Only the R output 36 is shown working in a left fulcrum roll cycle. A gasoline engine 46 powers the hydraulic rotary pump 48a which provides live hydraulic fluid to the two way double ended hydraulic cylinder 48c which supplies uniform Effort forces in a to and fro fashion via the first attachment member 48 which is connected at the discs 22 axis at 24 with a connecting pin and bushing. The 2nd attachment member 50 is connected with a connecting pin and bushing at 36, (the 3^{rd} attachment member not shown connects at point 36a and to the opposite direction, and to its piston pump, etc.) and to the one way piston pump 52 of which its live hydraulic forces are stored in an equalizer accumulator tank 54 (a sectioned off part of the tank 54 is at atmospheric pressure for a return oil reservoir). This live hydraulic fluid and its forces are transmitted to the hydraulic rotary piston motor 55, which is operatively connected to electric generator 49, of which supplies electric forces to the battery 57.

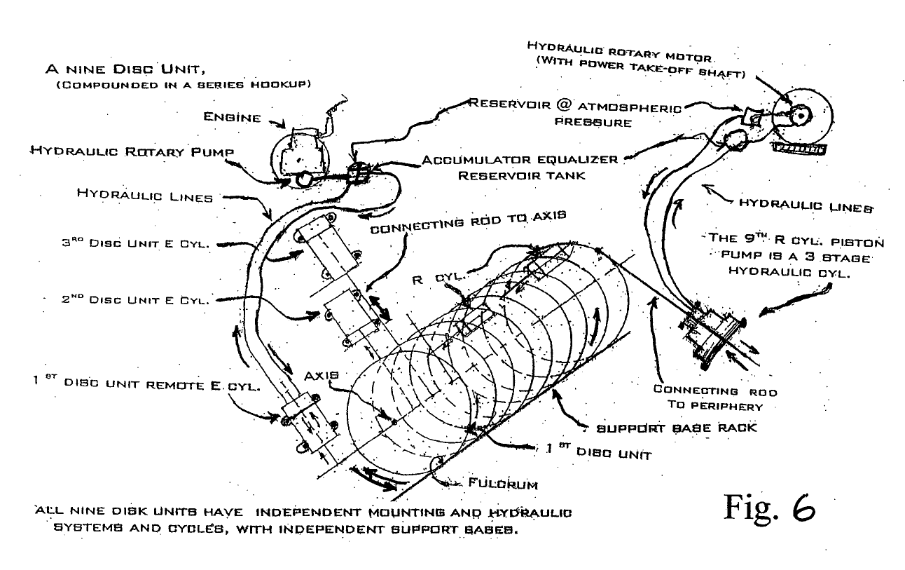

This FIG. 6 is a modification of the disc lever in the form of “series compounding” of a number of disc units independently ganged together. The E and R forces are compounded in a “series hookup”, meaning that each E force, starting at the first disc unit axis, are respectively connected and hydraulically proportioned to the next R force output cylinder in line etc. A small “job rated” internal combustion engine supplies the initial energy source applied to a hydraulic positive displacement rotary pump. All the “nine E cylinders” are two way hydraulic slave cylinders with their rods connected with a pin and bushing to their respective discs axis. Each of the Nine Disc Units has the same fulcrum roll motion cycles, and all have their own independent hydraulic systems. All of the “nine R output cylinders” are one way piston pumps connected operatively to their respective point of R output on their individual discs. The ninth R cylinder is a three stage telescopic piston pump which provides proportioned live fluid into each of its three different size stages in three declining increments. Starting with the largest stage, the higher starting R output force is transmitted via live proportioned hydraulic fluid into the first stage force chamber. This first stage piston force area is correlated to accept the larger declining R force “at the bottom or end” or where that stage stops. It does this in three declining increments with all three stages. At the finish of the last stage is where equilibrium occurs. A builder can mix and match common Hydraulic cylinders and multi-stage cylinders for various hydraulic purposes. In that manner, the amount of displacement and the declining force output can be critically regulated and controlled along with the compounding force procedure, and still provide a higher then average efficiency. The declining R output force is transmitted by live fluid into the pressurized accumulator equalizer tank system for distribution to the receiving positive displacement R output rotary motor, and provided for power takeoff. All the spent hydraulic fluids are piped and returned to atmospheric pressure reservoirs and re-circulated. Some hydraulic cylinders, automatic valves, electrical and various other parts, including encasement, frame and support structure are not shown.

### DESCRIPTION OF THE PREFERRED EMBODIMENT

With reference now to the drawings, and in particular to FIGS. 4 and 5 in their broadest context include a support base, a circular member, a selected fulcrum arc segment, an input power member, a first attachment member, various hydraulic cylinders, hydraulic cylinder piston pumps and motors, various force chamber configurations, a second attachment member, a third attachment member, a reservoir at atmospheric pressure, a pressurized force accumulator tank and an output power member. Such components are individually configured and correlated with respect to each other so as to attain the desired objective.

First provided is a horizontal support base 14. The support base is formed in a generally linear configuration. The base has a top surface 16. The top surface has equally spaced gear teeth 18 shown with a center support rail. In this manner, a rack with a center support rail is formed. A (disc) gear 22 is provided next. The disc has a central axis 24. The unneeded parts of the disc may be cut away, or it can be of “another shape modification”. Equally spaced and preferably small in size gear teeth 26 are provided. A steel tire 26A with the same diameter as the gear 22 is sandwiched between the teeth 26. This steel tire 26A supports the disc 22 and rolls on the rail 18A. The teeth give stability and effect the disc so as not to slide or translation occur while the disc is rolling (working) under the stress of force. Next is a first attachment member 48. This first attachment member 48 is formed as a reciprocating coupling which travels parallel to the base 14. One end of the first attachment member 48 is secured by a connecting pin and bushing to the axis of the pinion. The other end of the first attachment member is connected to the two way double ended hydraulic piston pump 48c (mounted to a frame not shown) which has automatic reverse flow control valves (not shown), and a reservoir at atmospheric pressure for spent hydraulic fluid is encased within an enclosure, also not shown. This 48c two way double ended hydraulic cylinder converts the uniform hydraulic forces provided by the live fluid from rotary piston pump 48a, to “measured to and fro motion cycles” of the disc on base 14. This “rotary” piston pump 48a is operatively connected and powered by input power member 46. 48b is a live oil supply line which transmits the (uniform Effort) forces from the rotary positive displacement piston pump 48a to the reciprocating two way double ended hydraulic cylinder 48c and of which reciprocates the first attachment member 48 and the disc in a to and fro fashion on base 14. Another oil line (not shown) returns the spent hydraulic oil from the reservoir to the rotary piston pump 48a. The first attachment member 48 also represents and lays out the trajectory of the E lines of force, which travel parallel to the base 14 and remain at 90 degrees to the start and finish constant length (the discs radius) E moments of force 22F and 22E.

Next provided is a second attachment member 50. This second attachment member is formed as a pivot able coupling. It is secured with a connecting pin and bushing to the “periphery” of the pinion at 36 and is movable between a first point A and a second point B (as shown in FIGS. 1 and 2). From the highest point 40 at the discs vertical diameter (as shown in FIG. 5), a line is scribed (on the back board frame as in FIGS. 1 and 3) to the right and parallel to the base 24.3873″. This 24.3873″ point is critical for the correct locating and placing of the one way hydraulic cylinder piston pump 52 as in FIG. 5, and for the specifications of most of the modifications. This piston pump 52 is pivot ably coupled at the equalizing tank frame and on to the second attachment member 50, which provides the critical and correct orientation of the R lines of force 22C and 22D as they relate to and at right angles to the growing and or changing R moments of force 22A and 22B as shown in FIG. 1. This said second attachment member 50 is connected with a connecting pin and bushing to the periphery at 36, and 24B (also as in FIGS. 3 and 6) is the fulcrum arc segment on the circular gear, which rolls and reciprocates a selected distance on the support base rack 14 between 24C and 24D, connected to a battery 57.

Although only one selected working area along the base rack is needed and with the above operative embodiment, the circular gears (disc) fulcrum arc segment 24B may be modified in length by rolling to another “selected by test” working area along the base rack. A selected working area is a chosen fulcrum arc segment which treats the R output force to be variable, starting out at a higher than average R force and declining to where a conventional force is at and stopping, reversing and reciprocating to and fro. During this to and fro cycling process, one R force output is giving and losing force, while the other or opposite side point of R output is under no stress of force and is in its recycling process gaining the advantage of position, preparing for its power roll cycle in the opposite direction. A preferred fulcrum roll segment area as in FIG. 3 is an area starting at 16,226 degrees to the right of top dead center or the discs vertical diameter. Then rolling left under the stress of the E and R forces 16.226 degrees to the left and stopping at top dead center, then reversing direction for an opposite roll cycle. There is a left and right top dead center 16.226 degrees apart with motion and forces, produce to and fro motion and rest cycles.

In a further alternate embodiment, the hybrid modification as shown in FIG. 4, the system further includes a third attachment member 214a on the left side of the circular gear shown with its associated piston pump 216. The third attachment member is formed as a pivotable coupling secured by a connecting pin and bushing to the periphery of the circular member on the opposite or left side of the high point and at an equal number of degrees from the highest point of the circular member as the second attachment member. Each of these second and third attachment members has an associated hydraulic piston pump 216, 218 with a common force equalizer accumulator pressurized reservoir tank 220 (air over hydraulics) also within the tank is another section which is a reservoir tank at atmospheric pressure and associated fluid lines 222 coupling the hydraulic motor 230 to the equalizer tank 220 which provide live and spent hydraulic fluid to and from hydraulic motor 230. A hybrid vehicle has a drive shaft 224 and has drive wheels 226, a differential 228, and hydraulic motor 230 turns the drive shaft 224. Not shown in FIG. 4 are the various automatic flow control valves, which direct the flow of live and spent hydraulic fluid. In this hybrid modification 215 is a D.C. electric motor (it could be internal combustion or other)-with a hydraulic rotary pump 48a, which provides live hydraulic fluid as an applied effort force to the remote two way double ended hydraulic cylinder 48c which changes rotary motion to reciprocating to and fro motion which activate the first attachment member 48 (which runs parallel to the support base 14), which is connected to the axis of the disc 24 with a pin and bushing. FIG. 4 also shows the right and left (2^{nd} and 3^{rd} attachment members) hook up point of the R output forces on the periphery designated as 212 and 212a and connected to the R force hydraulic cylinder pumps 216 and 218. FIG. 6 uses all the principles as illustrated in FIGS. 1-5 and incorporates them into a 9 independent disc units with its E and R forces compounded hydraulically in the form of series compounding.

As to the manner of usage and operation of the present invention, the same should be apparent from the above description. Accordingly, no further discussion relating to the manner of usage and operation will be provided.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent the United States is as follows:

1. A high efficiency device for the Conversion of Energy and Power Transfer formed as a Disc lever, and provided mainly within this invention is a modified simple machine, of which has a “movable fulcrum” which provides a changing mechanical advantage, and makes available changing ratio Effort and Resistance moment arms, with a proportionate changing virtual velocity ratio, by which provides a variable output force, and by which provides an above average amount of work “in a certain given distance and or time cycle”, and this combination provides an “above average efficiency.”

2. The Power Conversion system as set forth in claim 1; that within this combination of parts and forces is a configuration which effects, controls and directs equilibrium seeking forces in measured “to and fro cycles” of motion and rest, with an Applied Effort Force operatively connected at the axis of this disc lever, and also operatively connected and provided at selected points are, a right side and alternate left side points of Resistance output force on the periphery and provided by this combination of parts and E and R forces, is a new and useful above average output force, available in the same overall distance and or time increment as that of a comparable conventional lever system with the same distance and time segment cycle.

3. A power conversion system as set forth in claim 2; of which the said changing virtual velocity ratio consists of an applied Effort force of uniform velocity and a Resistance output force of a variable velocity.

4. A power conversion system as set forth in claim 3; of which the output forces are guided and directed to be changing and with output force cycles which include a higher magnitude which declines to where the force output of a comparable conventional unit's output is at, where rest is achieved and motion stops.

5. The system as set forth in claim 4; and in addition, common force compounding is incorporated with a selected number of circular disc units.

6. The system as set forth in claim 5; of which the compounding further includes supplemental input and output attachment members operatively coupled progressively to the next associated disc member, and each output attachment member having a “proportionate hydraulic piston pump” transmitting live fluid into an accumulator reservoir equalizer tank, which ultimately supplies and transmits live fluid to a hydraulic positive displacement output rotary motor, and the associated lines returning spent fluid to a common reservoir tank at atmospheric pressure.

7. The system as set forth in claim 2; that provided with the new unit's to and fro cycling process, one R force output is giving and losing R forces, while the other or opposite side point of R output is under no stress of force and is in its recycling process gaining the advantage of position, preparing for its power roll cycle in the opposite direction, this said cycling effect provides for a changing E and R moment arm ratio, effecting a proportionate changing E and R force ratio.

8. A power conversion system as set forth in claim 7; that with a given motion cycle the R moment arm grows in length providing a higher output R force starting and declining as it seeks equilibrium, and with this downhill force its motion cycle selectively stops and changes direction.

9. A power conversion system as set forth in claim 8; and of which this new inventions above average force output is accomplished in the “same overall distance and or time cycle” as that of a comparable pinned fulcrum conventional lever system with its same distance and or time increment, and this combination provides the machine of this invention with an above average output force value, and it is made available for use.

10. A power conversion system as set forth in claim 9; of which the applied effort force can be changed by modification from uniform to variable velocity providing a system that has an applied effort input force of variable velocity and a resistance output force of variable velocity.

11. The system as set forth in claim 2; and further including “modified applications” for the location of the input applied “effort forces and resistance output forces” and of which their points of application can be reversed and still provide an above average force, and these E and R forces can be located to other places then the axes and periphery of the disc, and applied (proportionately) anywhere in, on or about the disc.

12. The system as set forth in claim 10; that the only part of this disc that is needed is the critically selected fulcrum arc segment, and of which, the unneeded parts can be cut away allowing for the various length add on extended lever arms to be installed and located proportionately by selection, and of which this type modifying can and will effectively change the class of levers from a third class, proportionately to a 1^{st} or 2^{nd} class lever assembly.

13. The system as set force in claim 12; and of which this circular member disc can selectively be of any diameter large or small, thin or any thickness which may allow for proportionate hydraulic force surface areas for the forces to work on, in or within various shaped chambers, force chambers, common hydraulic cylinders and various custom designed multi-stage cylinders, and these compounded output forces are stored in various equalizer accumulator reservoir tanks and transmitted for motive use.

14. The system as set forth in claim 13; and further including support bases which can be other then flat or of a fixed type with a generally linear configuration such as round or other which can be used selectively to “increase or decrease” the display of motion as the circular members are compounded together with their forces in series hookup, and these compounded forces mixed and transposed to various size discs large and small, which also includes a method for increasing the display of motion by using and proportionately combining various hydraulics, and cylinders.

15. A high efficiency mechanical device for the Conversion of Energy and Power Transfer taking the form of a circle or disc type simple machine of which the input forces are directed to be of a uniform kind and that of the output forces are controlled and directed to be of a variable kind, and provided are continuous measured force cycles of motion and rest which include higher then average magnitude of force cycles and of which, with motion these forces start higher and decline to a point where the force output of a comparable conventional lever unit's output force is at, where motion stops and rest is achieved, and immediately the discs motion cycle is reversed for another higher then average output force cycle, in a continued reciprocating to and fro process of motion and rest.

16. The power conversion system of claim 15; in which the new invention provides the ability to do an above average amount of work in a certain distance and or time cycle, along with many various type E and R force combinations which can be utilized advantageously such as an electric motor, hydraulic motors, pumps, cylinders, multistage cylinders, accumulator tanks and reservoirs, the use of electro mechanical, linear and rotary solenoid actuators, linear and rotary electrical generators, magnetics, various compressed elements, steam, wind, etc., and combined with all the needed various associated parts, frames and mechanisms.

17. A power conversion system in which provided is a circular member disc of any size diameter large of small, and with a central axis, and equally spaced small in size gear teeth with a metal tire sandwiched between the teeth encompassing the circumference of the circular disc and thereby constituting a pinion which rolls on a rail, and this pinion sets upright (like a wheel on a road) on a horizontal support base which has a top surface with equally spaced gear teeth with a center rail, and thereby constituting a rack; and this pinion with its diameter measured from the free tip ends of the pinion teeth, the pinion teeth being adapted to contact and mesh with the rack teeth to allow the pinion to rotate ably move to the right and left along a linear path of travel on the rack, without having slipping or translation of the pinion on the support base occur;
a first attachment member formed as a connecting rod, one end secured with a connecting pin and bushing to the axis of the pinion and parallel to the support base; and the other end connected to the piston rod of a two way double ended hydraulic cylinder mounted to the frame, and of which motion of the piston occurs and cycles the disc when it receives live fluid from a hydraulic “rotary” piston pump which is operatively adapted to and powered directly from an input power member;
a second attachment member formed as a pivot able coupling secured with a pin and bushing connected to the upper periphery of the pinion and of which it is initially located at the top dead center of the pinion, and from that point the pinion is free rolled to the right to its desired work station segment location along the 64 degree length on the rack, where the fulcrum arc is free to rock and roll, providing for a given oscillatory displacement action on the support base, and the other end of this 2^{nd} attachment member is connected (parallel) and to the piston rod of the one way proportioned hydraulic R output cylinder piston pump, which is critically located and mounted pivot ably to the frame, from a point at the top of the discs initial high point “top dead center” location and to the right “a critical 24.3873” which is parallel to the support base;
an output power member formed as a rotary electrical generator with an output shaft operatively coupled to the hydraulic output force rotary motor which receives live hydraulic fluid from the hydraulic force equalizing reservoir tank, which receives its forces that are transmitted from the one way proportioned R output force hydraulic cylinder pumps (which are mounted pivotally to allow continued alignment of the R lines of force), and this output hydraulic cylinder rod is coupled to the second attachment member which places and locates the exact trajectory of the output lines of force, keeping them at 90 degrees to the growing R output moment of force, which are kept perpendicular to the movable fulcrum arc segment;
an input power member formed primarily as a internal combustion engine (many other type E and R force combinations can be utilized and they are various types such as an electric motor, hydraulic motors, pumps and cylinders, electro mechanical, linear and rotary solenoid actuators, linear and rotary electrical generators, magnetics, various compressed elements, steam, wind, etc.) and operatively coupled to a hydraulic rotary positive displacement piston pump, which operates and supplies live hydraulic fluid to a remote two way double ended hydraulic cylinder which develops an equal and uniform Applied Effort Force each way, of which its piston rod directly connects to one end of the first attachment member which provides reciprocating motion at the axis of the pinion; whereby power is efficiently transmitted from the engine through the configuration which provides a given oscillating motion of the pinion which continuously reciprocates the discs movable fulcrum arc segment on the support base rack;
and further including a third attachment member secured by a connecting pin and bushing to the periphery of the circular member gear on the opposite or left side of the high point, located and cycled in as an alternate R force output, used when the circular member rolls and reciprocates to the right (and left) in a to and fro continuous cycles of motion and rest, while activating proportionate left, (and right) R output hydraulic cylinder pumps continuously.
